(19) United States
(12) Patent Application Publication
(10) Pub. No.: US 2004/0267602 A1
(43) Pub. Date: Dec. 30, 2004

(54) Method, apparatus, and system for asymmetrically handling content requests and content delivery

(76) Inventors: Robert C. Gaydos, Harleysville, PA (US); Michael Chen, Wallingsford, PA (US)

Correspondence Address: NEEDLE & ROSENBERG, P.C., SUITE 1000, 999 PEACHTREE STREET, ATLANTA, GA, 30309-3915, US

(21) Appl. No.: 10/611,360

(22) Filed: Jun. 30, 2003

(51) Int. Cl. G06F 17/60

(52) U.S. Cl. 705/10

(57) ABSTRACT

Requests for content and delivery of content are handled in an asymmetric manner, with more bandwidth devoted to the delivery of the content than to the request for content. The request for content is sent upstream over a first network and then sent upstream to a content library over a second network. The content is retrieved from the content library, based on the request, and sent over a third network that is distinct (logically and/or physically) from the second network. The third network has high bandwidth compared to the bandwidth of the second network. The retrieved content is processed, which may include buffering and decrypting, and is then sent to the user. The retrieved content may be sent to the user downstream over the first network, using more bandwidth than the bandwidth used for sending the request upstream from the user.

### BACKGROUND

The present invention is directed to a method, apparatus, and system for handling user requests. More particularly, the present invention is directed to a method, apparatus, and system for asymmetrically handling content requests and content delivery.

In a multimedia subscriber system, such as a video on demand (VOD) system, servers are used to stream digital content through a network from a storage device, e.g., a disk array, to a user.

FIG. 1 illustrates a typical video on demand (VOD) environment, in which one or more video servers, including a server 160, provide a large number of concurrent streams of content from a content library 170 to a number of different users via set top boxes 150. Although only one server 160 is shown, a typical VOD system may include many servers. As represented in FIG. 1, the content library 170 is typically integrated with a server or multiple servers via a network switch.

In a typical VOD system, at the beginning of a VOD session, a set top box 150 sends a request for content, via the RF network 125 and headend components 100, to a session router 120. Although shown as separate entities for illustrative purposes, the headend components 100, session router 120, content server, and content library 170 are typically integrated in a hub.

The session router 120 determines which server 160 should receive the request, based on criteria including the availability of the requested content to the server. The content in the content library 170 is typically obtained in advance from an external source via, e.g., a satellite or terrestrial link, and stored in the content library as Moving Pictures Expert Group (MPEG) 2 packets, which are suitable for delivery to the set top box 150.

The request for content is routed to the appropriate server 160 over an application network 130. The application network 130 is typically an Ethernet link.

The server 160 retrieves the requested content from an integrated content library 170 via an internal storage network connection. Alternately, if the requested content is not in the integrated content library, the server 160 may pull the content from non-local storage by communicating with a library server associated with a content library in which the content is stored, over the application network 130.

The retrieved content is pushed from the server 160 to the headend components 100, and the headend sends the retrieved content to the set to box 150 over the RF cable network 125.

In this type of system, there are not distinct upstream and downstream paths between the content library 170 and the server 160. Rather, the server 160 requests and retrieves content over the same path, whether this path is an internal storage network connection for locally stored content or a connection with a library server for content that is not locally stored. In the latter case, since the application network 130 is not provisioned to accommodate significant amounts of content delivery, the bandwidth for delivering content is limited.

Also, in the conventional VOD system, there is a mismatch between the data throughput rate from the content library and the data rate at which the set top box operates. Content from the content library 170 is typically streamed as MPEG-2 transport packets at a rate of 160 Mbps (Mega bits per second) or more. The set top box 150, on the other hand, typically expects one transport stream packet approximately every 0.4 milliseconds, which translates to a data rate of about 3.75 Mbps. The set top box 150 operates most optimally when data is received at a constant data rate. Any deviation from the constant data rate results in jitter. Since the data rate output of the content library 170 far exceeds the desired output rate to the set top box 150, sending content from the content library to the set top box directly will create jitter. This problem may be aggravated by the packaging of the MPEG-2 transport packets retrieved from the content library into Ethernet frames for delivery. Also, variations in the time taken for delivery of data requests and delivery of content result in additional jitter.

Thus, there is a need for a technique for a system for handling content requests and delivery in a fast, efficient manner that maximizes bandwidth.

### SUMMARY

According to exemplary embodiments a method, apparatus, and system handle requests for content and delivery of content in an asymmetric manner, devoting more bandwidth to delivery of content than to requests for content.

According to one embodiment, a request for content is sent upstream from a user to at least one server over a first network. The request for content is sent from the server upstream to a content library over a second network. Content is retrieved from the content library, based on the request, and sent to the server over a third network. The third network is distinct (logically and/or physically) from the second network. Also, the third network has high bandwidth for delivering content downstream from the content library compared to the bandwidth of the second network for sending requests upstream to the content library.

The retrieved content is processed by the server for delivery downstream to the user. The processing may include, e.g., buffering, file system processing, and/or decryption. The buffering reduces variations in the rate of delivery of content.

According to an exemplary embodiment, after an initial request for content is sent to the content library, the server may continue sending subsequent requests for content. The server may continue requesting content from the content library while content previously requested is being retrieved by the content library, delivered to the server, and processed by the server.

According to one embodiment, the retrieved content may be delivered to the user over the first network. According to this embodiment, the downstream bandwidth of the first network is greater than the upstream bandwidth of the first network.

The objects, advantages and features of the present invention will become more apparent when reference is made to the following description taken in conjunction with the accompanying drawings.

### BRIEF DESCRIPTION OF THE DRAWINGS

FIG. 1 illustrates a conventional system for handling content requests and delivery;

FIG. 2 illustrates an exemplary system for handling content requests and delivery according to an exemplary embodiment;

FIG. 3 illustrates exemplary details of headend components handling content requests;

FIG. 4 illustrates exemplary details of server components handling content requests and content delivery;

FIG. 5 illustrates exemplary details of headend components handling content delivery; and

FIG. 6 illustrates an exemplary method for handling content requests and delivery according to an exemplary embodiment.

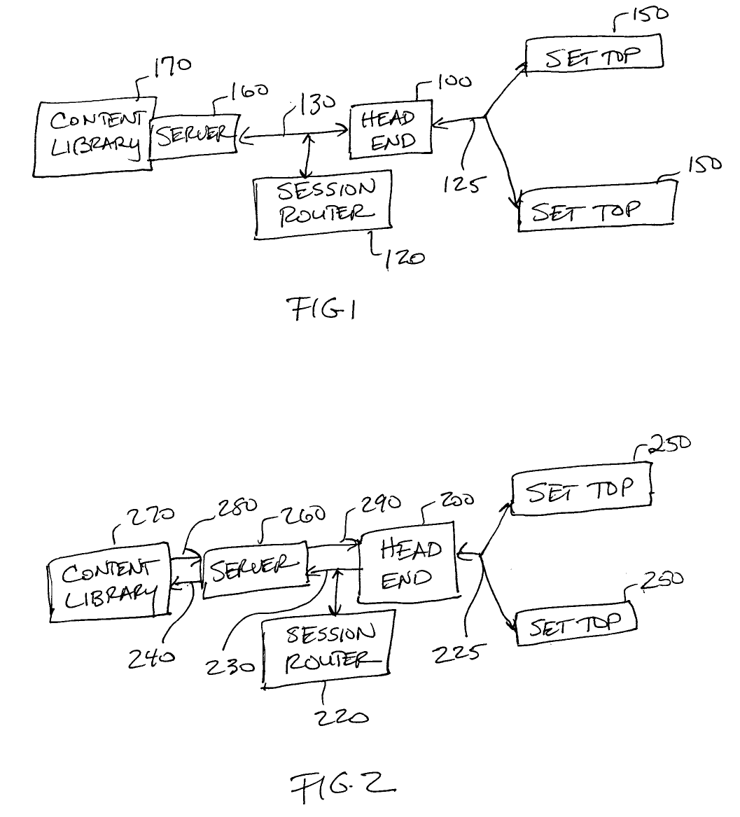

### DETAILED DESCRIPTION

According to exemplary embodiments, a method, apparatus, and system are provided for handling content requests and content delivery. In the following description, a system for requesting and delivering video content on demand is described for illustrative purposes. Throughout this description, terminology from the cable industry and RF networks shall be utilized for illustrative purposes. However, the invention is not limited to cable embodiments but is applicable to any type of communication network including, but not limited to, satellite, wireless, digital subscriber line (DSL), cable, fiber, or telco.

FIG. 2 illustrates an exemplary system for handling content requests and delivery according to an exemplary embodiment. A user initiates a request for content at a set top box 250. According to an exemplary embodiment, the set top box 250 includes any type of processor utilized and connected to the network for the receipt and presentations of content received via a viewing devices, such as, but not limited to, a television. The set top box 250 may be similar to those used in conventional systems with two-way connectivity and processing ability.

The user initiates a request by, e.g., pressing a button, using infrared remote, etc. The request is interpreted by the set top box 250 and sent over a network 225 to a headend 200.

The set top box 250 may send the user request without interpretation to the headend 260. Alternately, the set top box 250 may reinterpret the request and send another request. As an example of reinterpreting the request, the set top box 250 may map the keypress to an asset ID identifying content to be retrieved and send the asset ID. The asset ID is, in turn, mapped to a file name for the server 260 to use. According to an exemplary embodiment, this mapping may be performed by the server 260 or by a session router 220 connected to the headend 200.

According to an exemplary embodiment, the headend 200 includes equipment for receiving and managing content requests and for receiving and distributing retrieved content, including processing, manipulation, coding, and/or integration of the content and the network with other transport media. The headend 200 may be at any location on the network.

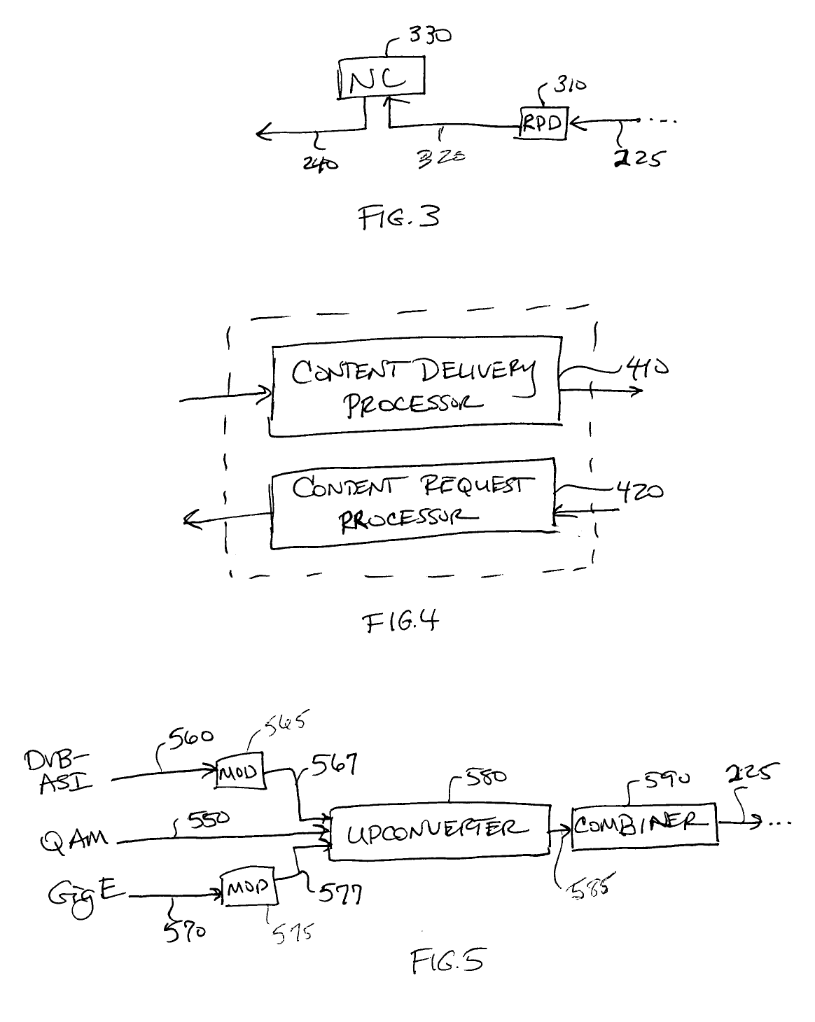

FIG. 3 illustrates exemplary details of headend components that handle a request. The headend 200 includes a return path demodulator (RPD) 310 that receives a request from the set top box 250 via the network 225. The RPD 310 demodulates the request from the set top box 250 and sends the demodulated request to a network controller (NC) 330 via an Operations, Administration, Maintenance and Provisioning (OAM&P) network 320. The OAM&P network provides necessary controls for service providers to provision and maintain high levels of voice and data services from a single platform.

The NC 330 sends the request to the server 260 via the application network 240. The request protocol between the RPD 310 and the NC 330 may differ from the request protocol between the NC 330 and the server 225. Thus, the request may be interpreted into another protocol by the NC 330.

Referring again to FIG. 2, the session router 220 determines which server should receive the request by examining, at least, the connections between the servers and the content library (or libraries) in which the requested content is stored. The request is processed by the headend 200 for delivery to the selected server 260 over an application network 230. The application network 230 may be of multiple types, including but not limited to, an Ethernet.

The server 260 processes the content request and sends it to a content library 270 via a network 240. The network 240 may be, e.g., a satellite, Internet, Ethernet, Asynchronous Transfer Mode (ATM), Wide Area Network (WAN), Metropolitan Area Network (MAN), Local Area Network (LAN), ExtraNet, Fibre Channel (FC) or wireless Ethernet network. The network 240 may be logically and/or physically distinct from the application network 230.

Although depicted as separate entities for illustrative purposes, it will be appreciated that the session router 220 and the server 260 may be integrated within the headend 200. Also, although FIG. 2 only depicts one headend 200, it will be appreciated that functions of the headend 200 may be distributed among various locations. Further, although only one server 260 and one content library 270 are shown in FIG. 2, it will be appreciated that there may be multiple servers and/or content libraries.

Content is retrieved from the content library 270 either directly or by a content library server (not shown). For example, according to one exemplary embodiment, content may be delivered from the content library 270 to the server 260 as raw data, and the server 260 may perform file system processing of the data. The file system data, including e.g., directory structures, free lists, etc., may be retrieved as raw data as well from the content library 270, in which case the server 260 translates the file system data in order to determine where the raw data is. According to this embodiment, the file system processing of the retrieved content occurs at the server 260. In this embodiment, a Small Computer System Interface (SCSI) protocol for TCP/IP may be used to access the content in the content library, and then the server 260 interprets the data blocks. Other protocols, including but not limited to an FC protocol, may also be used. This type of processing is important when any kind of RAID (redundant array of inexpensive disks) is used because if a block of content is missing or unavailable, the server 260 may request other data and reconstruct the missing data locally.

Also, the file system data may be distributed and stored on the server 260, with the content library 270 containing only the raw data. In this embodiment, RAID may be implemented in the content library server, but the file system is still maintained by the server, either remotely or locally.

According to another embodiment, a content library server may export a file system interface to the server 260. According to this embodiment, reconstruction of missing data is done transparently by opening and reading a file in the content library 270. The file reading hides the reconstruction.

According to one embodiment, access to the content library 270 may be controlled by encrypting the file system. The server 260 may communicate with a security server (not shown) to obtain a key and use the key to gain access to the content library. Alternately, a key known only by the server 260 may be used to encrypt the file system.

Decryption may occur at the content library 270 while retrieving content, at the server 260 while processing retrieved content, at components in the headend 200, at the set top box 250 while receiving content, or at nay combination of these. One or more encryption schemes, e.g., share-secret symmetric ciphers, such as Data Encryption Standard (DES) ciphers, or public-key asymmetric ciphers, such as Rivest, Shamir, and Adelman (RSA) ciphers, may be used, separately or simultaneously.

According to an exemplary embodiment, content stored in the content library 270 may be obtained in advance via, e.g., a satellite or terrestrial link. The content may be stored in the form of, e.g., MPEG-2 packets which are suitable for delivery to the set top box 250. Alternately, the content may be stored in another form, e.g., MPEG-4 packets, which may be modified, e.g., transcoded, in real time by the server 260 as appropriate for ultimate delivery to the set top box 250.

The content packets retrieved from the content library 270 are transmitted to the server 260 via a downstream network 280 that is distinct from the network 240. The network 280 may include, e.g., a gigabit-class optical network. Also, the network 280 may be unidirectional to increase bandwidth efficiency.

Although not shown, it will be appreciated that a switch and/or long-haul optical transport gear may be used as part of the network 240 and/or the network 280.

Also, although the networks 240 and 280 are described above as being two distinct physical networks, it will be appreciated that these networks may be part of the same physical network but be logically distinct. For example, the networks 240 and 280 may be distinct logical networks in an optical fiber ring.

The server 260 performs any required description and/or file system processing of the retrieved content and packages the content for delivery to the headend 200. The server 260 also buffers the retrieved content, compensating for differences in the data rate output from the content library and the desired output rate to the set top box 250. This buffering also compensates for data rate differences caused by packaging of the retrieved content into packets for transmission from the server 260. This buffering reduces the variation in the rate of delivery of the content to the user, thus reducing jitter.

After buffering, the server 260 delivers the retrieved content to the headend 200 via a delivery network 290. The delivery network 290 may include one or more networks, such as a Quadrature Amplitude Modulated (QAM) network, a Digital Video Broadcasting-Asynchronous Serial Interface (DVB-ASI) network, and/or a Gigabit Ethernet (GigE) network. The network topology depends on the server output format.

FIG. 4 shows exemplary details of a server 260. The server includes a content request processor 410 for interpreting the request from the headend 200 and generating a separate request. This involves, e.g., forming multiple file read requests for the file name requested and translating the file read requests into mass storage read commands, such as, but not limited to, SCSI or Fibre Channel read commands. The request processor 410 may also generate any required authorization to gain access to the content in the content library.

For receiving content, the server 260 also includes a content delivery processor 420 that processes content retrieved from the content library 270. This processing may include decrypting the retrieved content, performing any necessary file system processing, formatting the content for delivery to the headend and user and buffering the content to reduce jitter. The formatting may include transforming the content data from its storage format into MPEG-2 transport stream packets, if necessary. Also, the retrieved content may be multiplexed with other content, e.g., in the case of QAM or DVB-ASI output. For outputting a QAM signal, the server 260 also performs modulation onto a frequency carrier.

The components shown in FIG. 4 may be implemented with special purpose hardware. Alternately, one or more of these components may be implemented by a one or more microprocessors programmed to perform the appropriate functions.

Referring again to FIG. 2, the headend 200 processes the retrieved content and sends it to the set-top box 250 over the network 225. According to an exemplary embodiment, the retrieved content may be sent over an RF network as a different encoded signal and at a different frequency than the request.

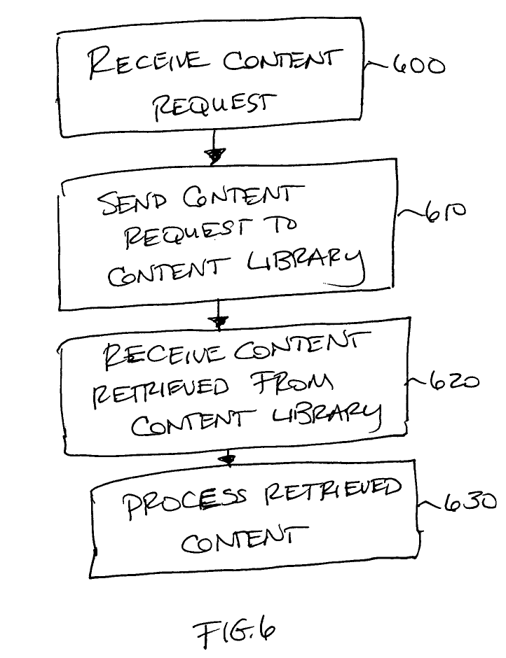

FIG. 5 illustrates exemplary details of headend components for content delivery. As shown in FIG. 5, the headend components for processing retrieved content include different paths for handling different types of signals from the server. These paths may be unidirectional to maximize bandwidth.

If the server 260 outputs the retrieved content as a QAM signal, this signal is received by the headend as an intermediate-frequency (IF) signal over a coaxial cable 550. The IF signal is received by an upconverter 380 that changes the frequency of the signal from the IF to the desired RF channel frequencies and sends the signal to a combiner 590 via a coaxial cable 585. The combiner 590 combines the RF signals and sends the combined signal to the RF network 125 for distribution to the set-top.

If the signal output by the server is a DVB-ASI digital signal, this signal is received by the headend as a digital signal over a cable network 560. The received signal is transformed into a QAM modulated signal in a modulator 565 and passes to the upconverter 580 via a coaxial cable 565. Similarly, if the signal output by the server is a digital GigE signal, this signal is received by the headend as Internet Protocol (IP) traffic over a fiber 570. The received signal is transformed into a QAM modulated signal by a modulator 575 and passed to the upconverter 580 via a coaxial cable 577. In both cases, the QAM modulated signal is upconverted to RF channel frequency signals in the upconverter 580 and combined for distribution in the combiner 595, as described above.

Although two separate modulators are depicted in FIG. 5 for the DVB-ASI signal and the GigE signal, it will be appreciated that the DVB-ASI signal and the GigE signal may be modulated in the same device. Also, although the modulators 565 and 575 are shown separately from the upconverter 580, it will be appreciated that the modulators may be included in the same device as the upconverter.

Further, although the QAM, DVB-ASI and GigE networks are shown in FIG. 5 as having common components, it will be appreciated that each of these networks may have fewer common components or have completely distinct components.

According to an exemplary embodiment, once the initial request has been sent from the server 260 to the content library 270, and the content library 270 sends the retrieved content at a rate specified in the request, requests may be continually repeated. Thus, while the server 260 buffers content and sends content to the headend 200 for delivery to the subscriber, the server 260 continues to receive and forward requests for more content. If content is missing, requests for the missed content may be sent back and multiplexed in with the autonomous sending. The net effect is less upstream traffic to the content library. This pattern may repeat until a request to stop and change file position or pause is encountered, e.g., a request to move to the next chapter or pause during a trick mode. During a trick mode, which may include but is not limited to fast forward or rewind, data is streamed from a different file, the trick file, for a given session.

FIG. 6 illustrates exemplary steps performed by a server for handling content requests and content delivery according to an exemplary embodiment. The method begins at step 600 at which a request for content is received by the server from a set top box. This request may be sent to the server after processing by the headend. At step 610, the server processes the request and sends it to the content library. At step 620, the server receives content retrieved from the content library. According to an exemplary embodiment, this content is sent to the server from the content library over a network that is distinct (logically and/or physically) from the network used to send the request from the server to the content library. At step 630, the server processes the retrieved content. This processing may include, for example, decrypting and buffering of the retrieved content. After being processed, the retrieved content is delivered to the set top via, e.g., the headend and an RF network.

Once the initial content request is fulfilled, steps 610, 620 and 630 may be repeated and performed concurrently for handling subsequent requests.

It should be understood that the foregoing description and accompanying drawings are by example only. A variety of modifications are envisioned that do not depart from the scope and spirit of the invention. For example, although the examples above are directed to storage and retrieval of video data, the invention is also applicable to storage and retrieval of other types of data, e.g., audio data and binary large object (blob) data.

The above description is intended by way of example only and is not intended to limit the present invention in any way.

What is claimed is:

1. A method for handling content request and delivery, comprising the steps of:
receiving at least one request for content sent upstream from at least one user over a first network;
sending the request for content upstream to a content library over a second network;
receiving content retrieved from the content library, based on the request, and sent downstream from the content library over a third network, wherein the third network is distinct from the second network; and
processing the retrieved content for delivery downstream to the user.

2. The method of claim 1, wherein the step of processing comprises buffering the retrieved content.

3. The method of claim 2, wherein the buffering of the retrieved content reduces variations in a rate of delivery of the retrieved content to the user.

4. The method of claim 1, further comprising sending the retrieved content downstream to the user over the first network.

5. The method of claim 4, wherein the downstream bandwidth of the first network is greater than the upstream bandwidth of the first network.

6. The method of claim 1, wherein the first network includes an RF network.

7. The method of claim 1, wherein the third network has high bandwidth for delivering content downstream from the content library compared to the bandwidth of the second network for sending requests upstream to the content library.

8. The method of claim 1, wherein the second network and the third network are distinct logical networks.

9. The method of claim 8, wherein the second network and the third network are distinct physical networks.

10. The method of claim 1, wherein after an initial request for content is sent to the content library, the step of sending a request for content is repeated for subsequent requests.

11. The method of claim 10, wherein if content is lost before being delivered downstream to the user, a request for the lost content is sent upstream to the content library along with a subsequent request for content.

12. The method of claim 10, wherein the step of sending a request for content is performed while content retrieved based on previously sent requests is received and processed.

13. The method of claim 1, wherein the requested content includes at least one of video data, audio data and binary large object data.

14. The method of claim 1, wherein the user is associated with a content-on-demand subscriber.

15. The method of claim 1, wherein the retrieved content received from the content library is in an encrypted form, and the step of processing includes decrypting the encrypted retrieved content.

16. The method of claim 1, wherein the step of sending the request for content includes sending authentication information to gain access to the content in the content library.

17. The method of claim 1, wherein the content library is associated with a content library server that performs file system processing on the content retrieved from the content library.

18. The method of claim 1, wherein the content retrieved from the content library is received as raw data, and the step of processing includes performing file system processing on the retrieved content.

19. The method of claim 1, wherein the step of processing includes transforming the retrieved content into a format suitable for delivery to the user.

20. An apparatus for handling content request and delivery, comprising:
means for receiving at least one request for content sent upstream from at least one user over a first network;
means for sending the request upstream to a content library over a second network;
means for receiving content retrieved from the content library based on the request and sent downstream from the content library over a third network, wherein the third network is distinct from the second network; and
processing means for processing the retrieved content for delivery to the user.

21. The apparatus of claim 20, wherein the processing means includes means for buffering the retrieved content.

22. The apparatus of claim 21, wherein the buffering means reduces variations in a rate of delivery of the retrieved content to the user.

23. The apparatus of claim 20, further comprising means for sending the retrieved content downstream to the user over the first network.

24. The apparatus of claim 23, wherein the downstream bandwidth of the first network is greater than the upstream bandwidth of the first network.

25. The apparatus of claim 20, wherein the first network includes an RF network.

26. The apparatus of claim 20, wherein the third network has high bandwidth for delivering content downstream from the content library compared to the bandwidth of the second network for sending requests upstream to the content library.

27. The apparatus of claim 20, wherein the second network and the third network are distinct logical networks.

28. The apparatus of claim 27, wherein the second network and the third network are distinct physical networks.

29. The apparatus of claim 20, wherein after an initial request for content it sent to the content library, the sending means sends subsequent requests.

30. The apparatus of claim 29, wherein if content is lost before being delivered downstream to the user, a request for the lost content is sent upstream to the content library along with a subsequent request for content.

31. The apparatus of claim 29, wherein the sending means sends requests for content while the content retrieved based on previously sent request is received by the receiving means and processed by the processing means.

32. The apparatus of claim 20, wherein the requested content includes at least one of video data, audio data, and binary large object data.

33. The apparatus of claim 20, wherein the user is associated with a content-on-demand subscriber.

34. The apparatus of claim 20, wherein the retrieved content received from the content library is in an encrypted form, and the processing means includes means for decrypting the encrypted retrieved content.

35. The apparatus of claim 20, wherein the means for sending the request for content sends authentication information to gain access to the content in the content library.

36. The apparatus of claim 20, wherein the content library is associated with a content library server that performs file system processing on the content retrieved from the content library.

37. The apparatus of claim 20, wherein the content retrieved from the content library is received as raw data, and the step of processing includes performing file system processing on the retrieved content.

38. The apparatus of claim 20, wherein the processing means transforms the retrieved content into a format suitable for delivery to the user.

39. A system for handling content request and delivery, comprising:
a first network over which at least one request for content is received upstream from at least one user;
at least one server for receiving the request for content sent upstream from the user over the first network;
a second network over which the request is sent upstream from the server;
a content library for receiving the request sent upstream from the server, wherein content is retrieved from the content library based on the request; and
a third network for delivering the retrieved content from the content library downstream to the server, wherein the server processes the retrieved content for delivery downstream to the user.

40. The system of claim 39, wherein the server buffers the retrieved content.

41. The system of claim 40, wherein the buffering reduces variations in a rate of delivery of the retrieved content.

42. The system of claim 39, wherein the server sends the retrieved content downstream to the user over the first network.

43. The system of claim 42, wherein the downstream bandwidth of the first network is greater than the upstream bandwidth of the first network.

44. The system of claim 39, wherein the first network includes an RF network.

45. The system of claim 39, wherein the third network has high bandwidth for delivering content downstream from the content library compared to the bandwidth of the second network for sending requests upstream to the content library.

46. The system of claim 39, wherein the second network and the third network are distinct logical networks.

47. The system of claim 46, wherein the second network and the third network are distinct physical networks.

48. The system of claim 39, wherein after an initial request for content is sent to the content library, the server continues sending subsequent requests for content.

49. The system of claim 48, wherein if content is lost before being delivered downstream to the user, a request for the lost content is sent upstream to the content library along with a subsequent request for content.

50. The system of claim 48, wherein the server continues requesting content from the content library while content is being retrieved based on previously sent requests, delivered to the server, and processed by the server.

51. The system of claim 39, wherein the requested content includes at least one of video data, audio data, and binary large object data.

52. The system of claim 39, wherein the user associated with a content-on-demand subscriber.

53. The system of claim 39, wherein the content is received at the server in an encrypted form, and the processing performed by the server includes decrypting the retrieved content.

54. The system of claim 39, wherein the server sends authentication information with the request for content to the content library to gain access to the content in the content library.

55. The system of claim 39, wherein the content library is associated with a content library server that performs file system processing on the content retrieved from the content library.

56. The system of claim 39, wherein the content retrieved from the content library and sent to the server is raw data, and the server performs file system processing on the retrieved content.

57. The system of claim 39, wherein the server transforms the retrieved content into a format suitable for delivery to the user.
